(19) United States
(12) Patent Application Publication
(10) Pub. No.: US 2022/0250229 A1
(43) Pub. Date: Aug. 11, 2022

(54) DRIVER ATTACHMENT DEVICE

(71) Applicant: Bryan Hampton, Apopka, FL (US)

(72) Inventor: Bryan Hampton, Apopka, FL (US)

(21) Appl. No.: 17/170,253

(22) Filed: Feb. 8, 2021

(51) Int. Cl. B25F 5/02

(52) U.S. Cl. CPC B25F 5/029

(57) ABSTRACT

A driver attachment device includes a planar base portion having an upper surface, a lower surface, and an aperture extending through the upper and lower surfaces. A gripping surface extends downward from the lower surface of the base portion and function to prevent lateral or rotational movement of the device when secured to the drill via a screw positioned through the aperture. A pair of elongated resilient arms extend upward from the upper surface of the base portion along the pair of side surfaces. The resilient arms including a plurality of sections and bends that form a central receptacle for receiving and storing a drill bit driver. The central receptacle including a generally hexagonal shape having a dimension that is complementary to the industry standard dimensions of a commercially available drill bit driver. A plurality of magnetic elements is provided along the resilient arms and function to magnetically engage an inserted drill bit driver to prevent lateral movement of the driver.

### TECHNICAL FIELD

The present invention relates to a driver attachment device for receiving and storing drill bit drivers onto an electric drill or screwdriver.

### BACKGROUND

The statements in this section merely provide background information related to the present disclosure and may not constitute prior art.

When working with an electric drill, it is not uncommon to utilize many different types of drill bit drivers such as a phillips head driver, a flat head driver, or a socket driver, for example. Indeed, many workers routinely keep multiple drivers in their pockets so that they can be retrieved and swapped without having to return to their toolbox. Unfortunately, these drivers often fall out of the user's pockets or otherwise get lost because they do not remain in close proximity to the drill.

Although most commercially available drills come with a belt clip for securing the drill onto a belt or other such article of a user, there does not currently exist an attachment device which can receive and store one or more driver attachments onto the drill itself.

Accordingly, it would be beneficial to provide a driver attachment device that can be used with any type of electric screwdriver/drill to alleviate the drawbacks described above.

### SUMMARY OF THE INVENTION

The present invention is directed to a driver attachment device for selectively receiving and positioning a drill bit driver onto a power drill. One embodiment of the present invention can include a planar base portion having an upper surface, a lower surface, and an aperture extending through the upper and lower surfaces. A screw can be provided for securing the base portion to a power drill via the aperture, and a gripping surface can extend downward from the lower surface of the base portion. The gripping surface can function to prevent lateral or rotational movement of the device when secured to the drill.

In one embodiment, a pair of elongated resilient arms can extend upward from the upper surface of the base portion along the pair of side surfaces. The resilient arms including a plurality of sections and bends that form a central receptacle for receiving and storing a drill bit driver. The central receptacle can include a generally hexagonal shape having a dimension that is complementary to the industry standard dimensions of a commercially available drill bit driver.

In one embodiment, a plurality of magnetic elements is provided along the resilient arms and function to magnetically engage an inserted drill bit driver to prevent lateral movement of the driver.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front view of a driver attachment device that is useful for understanding the inventive concepts disclosed herein.

FIG. 2 is a perspective view of the driver attachment device in accordance with one embodiment of the invention.

FIG. 3 is a perspective view of the driver attachment device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work together to join two items together in a permanent or nonpermanent manner. Several nonlimiting examples include opposing strips of hook and loop material (i.e., Velcro®), attractively oriented magnetic elements, tethers, buckles, and compression fittings such as latches, hooks, snaps and buttons, for example.

FIGS. 1-3 illustrate one embodiment of a driver attachment device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

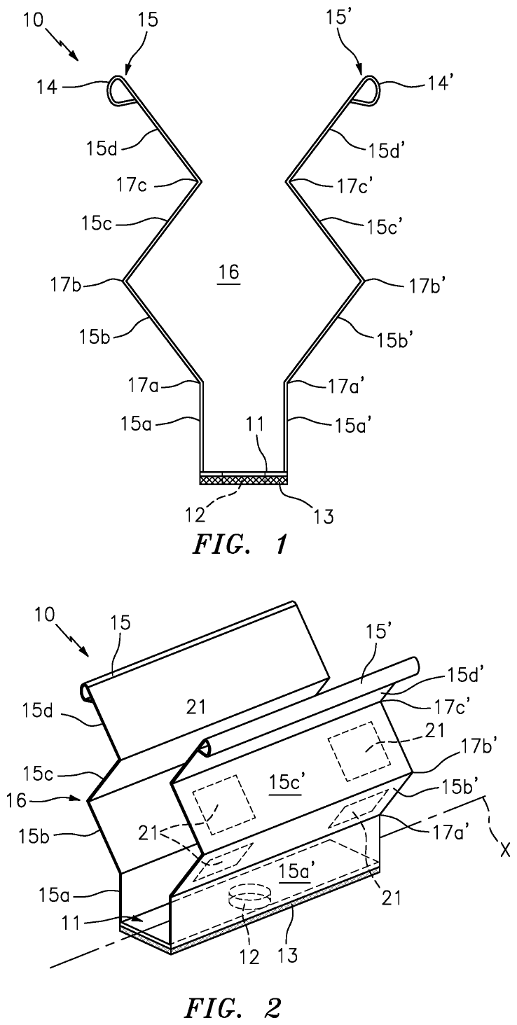

As shown best at FIGS. 1 and 2, the device 10 can include a substantially flat base portion 11 having at least one aperture 12 positioned centrally therethrough, a gripping surface 13 and a pair of elongated resilient arms 15 and 15′.

In one embodiment, the gripping surface 13 can be positioned along the bottom surface of the base portion 11 so as to aid in gripping a power drill 1 or other such component to which the device 10 is secured. In one embodiment, the gripping surface can comprise a series of sharp protrusions extending outward from the base portion which are designed to partially penetrate the drill surface in order to prevent the device from sliding, rotating or otherwise moving when secured to the drill with a screw 2 positioned through the aperture 12. Of course, many other types of gripping surfaces may be provided. For example, gripping surface 13 can comprise a strip of high friction material such as rubber, for example, which resists movement of two surfaces between which it is placed.

In one embodiment, the pair of elongated arms 15 and 15′ can include a mirror image shape and can be positioned parallel to each other while extending upward and away from opposite ends of the base portion 11. To this end, each of the arms can include a plurality of bends which form a central receptacle 16 into which a drill driver 5, a drill bit or other such attachment can be positioned and stored in a parallel orientation with the major axis X of the device 10.

In the preferred embodiment, the distal ends 14 and 14′ of the elongated arms can include a rounded edge so as to better guide a drill bit into the device and/or to remove sharpened edges that could harm a user. In either instance, the elongated arms can include a first section 15a and 15a′extending perpendicular from the base portion 11, a first bend 17a and 17a′ for positioning second sections 15b and 15b′ diagonally outward from the base portion 11, a second bend 17b and 17b′ for positioning third sections 15c and 15c′ diagonally inward toward the base portion 11, and a third bend 17c and 17c′ for positioning fourth sections 15d and 15d′ diagonally outward from the base portion 11.

In one embodiment, arms 15 and 15′ can be resilient in nature whereby bends 17a-17c and 17a′-17c′ can permit arm sections 15b-15d and 15b′-15d′ to move/flex perpendicular to the major axis X of the device. Accordingly, when a drill bit 5 or other such element is inserted between arm sections 15d-15d′and pushed downward, arm sections 15b-15c and 15b′-15c′ which form the central receptacle 16 can temporarily flex away from each other to permit resilient mounting of the driver 5 within the receptacle.

In one embodiment, one or more magnets 21 can be provided along or within the arms 15 and 15′. Each of the magnets 21 can function to magnetically engage an inserted drill bit 5 in order to secure the driver within the receptacle 16. Such a feature being particularly beneficial in preventing an inserted bit 5 from sliding linearly out of the device 10 (e.g., in a direction parallel with the major axis of the device).

Although illustrated with a particular number of arm sections forming a hexagonal-shaped central receptacle 16, that is complementary to the cross-sectional shape of a drill bit driver, this is for illustrative purposes only. To this end, other embodiments are contemplated wherein a different number of arm sections are provided so as to form a central receptacle having a different shape, so as to resiliently engage, receive and store components having different shapes, sizes and/or functions. Accordingly, the device is not to be construed as limiting to the illustrated shape or size.

In either instance, the driver attachment device 10 will preferably be constructed from a single piece of resilient material that is, for example, relatively strong for its weight. Several nonlimiting examples include but are not limited to various metals or metal alloys, various plastic/polymers, and/or various composite materials, for example. Of course, other embodiments are contemplated wherein the device is constructed from different parts or materials that are joined together to form the illustrated shape.

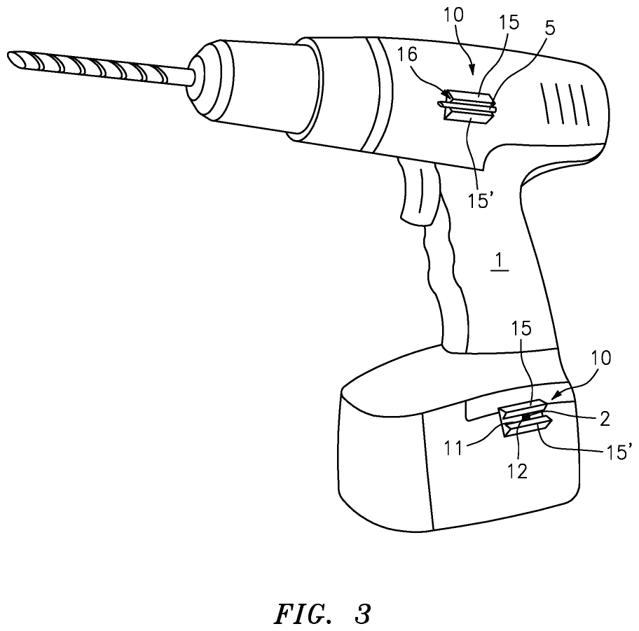

As shown best at FIG. 3, one or more driver attachment devices 10 can be secured onto a drill 1 or other component via a connector 2 such as a screw, for example, that is passed through the central aperture 12. When so positioned, the gripping surface 13 will be interposed between the drill and the device body 11 to prevent movement of the installed device. After installation, a drill bit driver 5 can be positioned between the resilient arms 15 and 15′ so as to be stored within the central receptacle area 16 as described above.

In one embodiment, the driver attachment device 10 can be manufactured so as to replace the belt clip device that comes standard with most commercially available drills. In this regard, the factory-supplied screw holding the belt clip onto the drill can be removed, and the belt clip can be discarded. Next, the factory-supplied screw can be passed through the central aperture 12 so as to be mated with the threaded opening on the drill. Such a feature permitting the device 10 to be mounted onto a drill using factory supplied hardware.

In another embodiment, a plurality of different shaped screws can be provided so as to mate with the threaded receptacle found on a drill. Each of the provided screws can be color coded to the drill brand to allow the user to easily install the device using a connector that is already sized to be compatible with their drill.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A driver attachment device, comprising:
a planar base portion having an upper surface, a lower surface, a pair of end surfaces and a pair of side surfaces;
a pair of elongated arms extending outward from the upper surface of the base portion along the pair of side surfaces;
a central receptacle that is formed by the pair of elongated arms, said central receptacle including a shape and a size that is complementary to a cross sectional shape and a size of a drill bit driver,
wherein the pair of elongated arms include a resilient construction.

2. The device of claim 1, wherein the pair of elongated arms are configured to flex in a direction perpendicular to a major axis of the device.

3. The device of claim 1, wherein the central receptacle includes a hexagonal shape.

4. The device of claim 3, wherein the central receptacle is positioned parallel to a major axis of the device.

5. The device of claim 1, wherein each of the pair of elongated arms includes a first section extending perpendicular to the base portion.

6. The device of claim 5, wherein each of the pair of elongated arms includes a second section extending diagonally away from the base portion.

7. The device of claim 6, wherein each of the pair of elongated arms includes a third section extending diagonally toward the base portion.

8. The device of claim 7, wherein each of the pair of elongated arms includes a fourth section extending diagonally away from the base portion.

9. The device of claim 8, wherein the central receptacle is formed by the second section and the third section of each of the pair of elongated arms.

10. The device of claim 1, further comprising:
an aperture that is positioned through a center section of the base portion.

11. The device of claim 10, wherein the aperture is configured to receive a connector for securing the device onto a drill.

12. The device of claim 11, wherein the connector comprises a screw.
